(19) United States
(12) Patent Application Publication
(10) Pub. No.: US 2010/0282079 A1
(43) Pub. Date: Nov. 11, 2010

(54) PROCESS FOR PREPARING AN ACTIVATED MINERAL

(76) Inventor: Harold Boerrigter, Amsterdam (NL)

Correspondence Address: SHELL OIL COMPANY, P O BOX 2463, HOUSTON, TX, 772522463, US

(21) Appl. No.: 12/600,690

(22) PCT Filed: May 16, 2008
(86) PCT No.: PCT/EP2008/056054

§ 371 Date: May 6, 2010

(30) Foreign Application Priority Data
May 21, 2007 (EP) 07108540.1
Jan. 25, 2008 (EP) 08100913.6

(51) Int. Cl. B01D 53/02; C01B 33/24

(52) U.S. Cl. 95/139; 423/331

(57) ABSTRACT

The invention provides a process for the activation of a magnesium or calcium sheet silicate hydroxide mineral comprising: (a) preheating magnesium or calcium sheet silicate hydroxide mineral particles to obtain preheated silicate hydroxide mineral particles; (b) activating the preheated silicate hydroxide mineral particles at elevated temperature to obtain at least hot activated mineral particles; and (c) cooling the hot activated mineral particles, wherein energy released during cooling in step (c) is used for preheating the magnesium or calcium sheet silicate hydroxide mineral particles in step (a) by heat-integration. The invention further provides an activated magnesium or calcium sheet silicate hydroxide mineral and a process for sequestration of carbon dioxide.

The present invention provides a process for the activation of a magnesium or calcium sheet silicate hydroxide mineral and an activated magnesium or calcium sheet silicate hydroxide mineral and a process for sequestration of carbon dioxide.

It is known that carbon dioxide may be sequestered by mineral carbonation. In nature, stable carbonate minerals and silica are formed by a reaction of carbon dioxide with natural silicate minerals:

(Mg,Ca)ₓSi_{y}O_{x+2y}+xCO₂ [symbol] x(Mg,Ca)CO₃+ySiO₂

It is known that orthosilicates or chain silicates can be relatively easily reacted with carbon dioxide to form carbonates and can thus suitably be used for carbon dioxide sequestration. Examples of magnesium or calcium orthosilicates suitable for mineral carbonation are olivine, in particular forsterite, and monticellite. Examples of suitable chain silicates are minerals of the pyroxene group, in particular enstatite or wollastonite.

In WO02/085788, for example, is disclosed a process for mineral carbonation of carbon dioxide wherein particles of silicates selected from the group of ortho-, di-, ring, and chain silicates, are dispersed in an aqueous electrolyte solution and reacted with carbon dioxide.

The more abundantly available magnesium or calcium silicate hydroxide minerals, for example serpentine and talc, are sheet silicates and are more difficult to convert into carbonates, i.e. the reaction times are much longer. Such sheet silicate hydroxides need to undergo a heat treatment or activation at elevated temperatures prior to the reaction with carbon dioxide.

In WO2007060149, a process is described for activating serpentine by conversion to olivine, wherein the serpentine is contacted with a hot synthesis gas. The activation of serpentine takes place at temperatures between 600 and 800° C. According to the disclosure of WO2007060149, below 600° C., there is no significant conversion of serpentine into olivine and above 800° C., a crystalline form of olivine is formed that is more difficult to react with carbon dioxide than the amorphous olivine formed at a temperature below 800° C. In order to provide sufficient energy to activate the serpentine, syngas is used with temperatures up to 1600°. The process disclosed in WO2007060149 is energy inefficient and consequently economically disadvantageous.

It has now been found that the energy necessary for activating sheet silicate hydroxides such as serpentine can be significantly reduced by heat integration of the separate stages of the activation process.

Accordingly, the present invention provides a process for the activation of a magnesium or calcium sheet silicate hydroxide mineral comprising:

(a) preheating magnesium or calcium sheet silicate hydroxide mineral particles to obtain preheated silicate hydroxide mineral particles;
(b) activating the preheated silicate hydroxide mineral particles at elevated temperature to obtain at least hot activated mineral particles; and
(c) cooling the hot activated mineral particles, wherein energy released during cooling in step (c) is used for preheating the magnesium or calcium sheet silicate hydroxide mineral particles in step (a) by heat-integration.

Heat integration herein relates to the transfer of energy, e.g. in the form of heat, released in one process step to another process step. Heat integration may be achieved by direct or indirect heat exchange. For instance, by directly contacting a first medium with second medium. Alternatively, the first medium and second medium can be brought in heat contact by heat exchange means such as for instance a heat exchanger. By using a fluid heat exchange medium, heat may be transferred over a certain distance. Well-known examples of fluid heat exchange media are steam or oil.

An advantage of the process of the invention is that a reduction of over 40% of the energy provided to the process may be achieved by implementing the heat integration as described in the present invention.

In the process according to the invention, a magnesium or calcium sheet silicate hydroxide mineral (herein below also referred to as silicate hydroxide mineral) is activated.

Silicates are composed of orthosilicate monomers, i.e. the orthosilicate ion SiO₄⁴⁻ which has a tetrahedral structure. Orthosilicate monomers form oligomers by means of O—Si—O bonds at the polygon corners. The Q^{S} notation refers to the connectivity of the silicon atoms. The value of superscript s defines the number of nearest neighbour silicon atoms to a given Si. Orthosilicates, also referred to as nesosilicates, are silicates which are composed of distinct orthosilicate tetrathedra that are not bonded to each other by means of O—Si—O bonds (Q⁰ structure). Chain silicates, also referred to as inosilicates, might be single chain (SiO₃²⁻ as unit structure, i.e. a (Q²)ₙ structure) or double chain silicates ((Q³Q²)ₙ structure). Sheet silicate hydroxides, also referred to as phyllosilicates, have a sheet structure (Q³)ₙ.

Above a certain temperature, a sheet silicate hydroxide, such as magnesium or calcium sheet silicate hydroxide mineral, is converted into its corresponding ortho- or chain silicate mineral, silica and water. Serpentine for example is converted at a temperature of at least 500° C. into olivine. Talc is converted at a temperature of at least 800° C. into enstatite. This process is referred to as activation. The temperature at which the activation commences is referred to as the activation temperature.

In the process according to the invention the activation of the silicate hydroxide mineral particles takes place at elevated temperatures, i.e. at or above the activation temperature. During the activation of the silicate hydroxide mineral at least part the silicate hydroxide mineral is converted into an ortho- or chain silicate mineral, silica and water. In case of for instance a magnesium silicate hydroxide mineral the activation may, for example, follow formula (I):

Mg₃Si₂O₅(OH)₄→1.5Mg₂SiO₄+0.5SiO₂+2H₂O(g) (1)

Preferably, the silicate hydroxide mineral is converted into an amorphous magnesium or calcium ortho- or chain silicate mineral.

Additionally, the activation of the silicate hydroxide mineral may include a conversion of part of the silicate hydroxide mineral into an amorphous magnesium or calcium silicate hydroxide mineral derived compound.

The product of the activation is an activated magnesium or calcium sheet silicate hydroxide mineral, further also referred to as activated mineral.

Prior to the activation of the silicate hydroxide mineral particles supplied to the process according to the invention, the silicate hydroxide mineral particles are preheated to a temperature close to the temperature at which the silicate hydroxide mineral particles are activated in step (b) of the process according to the invention.

The silicate hydroxide particles may be preheated to any desired temperature either below or above the temperature at which the preheated silicate hydroxide mineral particles are activated in step (b) of the process according to the invention. Preferably, the silicate hydroxide mineral particles are preheated to a temperature no more than 200° C. more preferably no more than 150° C., even more preferably no more than 100° C., below the temperature at which the preheated silicate hydroxide mineral particles are activated in step (b) of the process according to the invention. Preferably, the silicate hydroxide mineral particles are preheated to a temperature not more than 20° C., more preferably not more than 5° C., above the temperature at which the preheated silicate hydroxide mineral particles are activated in step (b) of the process according to the invention. Even more preferably, the silicate hydroxide mineral particles are preheated to a temperature equal to or below the temperature at which the preheated silicate hydroxide mineral particles are activated in step (b) of the process according to the invention. The advantage of preheating the silicate hydroxide mineral is that the residence time in the activation zone is reduced, resulting in a better control of the net residence time and extent of conversion. As a consequence, a narrow compositional spread may be obtained. Equally advantageous, by preheating the silicate hydroxide mineral particles a lower quality heat can be used, for instance very low pressure steam.

The activated mineral particles obtained from the activation step are hot due to the elevated temperatures of the activation process, typically at or close to the temperature of the activation process. However, further use of the activated mineral for instance carbon dioxide sequestration by mineral carbonation does not require the activated mineral to be at such high temperatures. In the process according to the invention, the hot activated mineral particles are cooled and at least part of the energy released during cooling is used to preheat the silicate hydroxide mineral particles in step (a) by heat integration. To avoid the need to provide additional means for solids transportation in order to bring the hot activated mineral in direct heat contact with the silicate hydroxide mineral particles of step (a), it is preferred to use a fluid heat transfer medium for transferring the heat from the hot activated mineral particles to the silicate hydroxide mineral particles. Examples of suitable heat exchange media include water, steam, oil or molten salt. The advantage of using hot activated mineral particles to preheat the silicate hydroxide mineral particles is that the energy stored in the hot activated mineral is reused to preheat the silicate hydroxide mineral. Consequently, less external energy needs to be supplied to the preheating step (a) of the process according to the invention.

As mentioned herein above, during the activation of the silicate hydroxide mineral water may be obtained, typically in the form of hot steam, i.e. steam having a temperature above 200° C., preferably above 500° C. This hot steam may also be used to preheat the silicate hydroxide mineral particles in step (a). The hot steam is preferably cooled and at least part of energy released during cooling of the hot steam is used for preheating the magnesium or calcium sheet silicate hydroxide mineral particles in step (a) by heat-integration. Preferably, the hot steam is brought into direct contact with the silicate hydroxide mineral particles in step (a) to allow for the most efficient heat transfer. Optionally, a heat exchanger may be used. The obtained cooled steam or water may be used for other purposes, such as in a carbon dioxide sequestration by mineral carbonation process.

The energy for activation can be supplied by for instance contacting the preheated silicate hydroxide mineral particles with a hot gas such as a hot flue gas or a hot syngas. A hot flue gas may for instance be obtained by reacting a fluid fuel with molecular oxygen to obtain a hot flue gas and heat. Such a reaction is typically referred to as combustion. The fluid fuel and molecular oxygen may be combusted to provide the heat for activating the preheated silicate hydroxide mineral particles in step (b). The obtained hot flue gas can subsequently be cooled and at least part of the energy released during cooling of the hot flue gas may be used for preheating the silicate hydroxide mineral particles in step (a) by heat integration. Preferably, the hot flue is brought into direct contact with the silicate hydroxide mineral particles to allow for the most efficient heat transfer. Optionally, a heat exchanger may be used.

The obtained cooled flue gas can be disposed of or may be directed to a mineral carbonisation process for carbon dioxide capture from the flue gas. The energy remaining in the flue gas after the activation process is now recovered and resulting less energy needs to be provided to preheat the silicate hydroxide mineral particles.

The efficiency of the activation process can be further improved by heating the molecular oxygen prior to combustion of the fluid fuel. Preferably, the molecular oxygen is heated prior to reacting the molecular oxygen with the fluid fuel. Preferably, at least part of the energy released during the cooling in step (c) is used for preheating the molecular oxygen by heat integration. Preferably, the molecular oxygen is directly contacted with the hot activated mineral particles. Optionally, a heat exchanger may be used.

Typically, the molecular oxygen will be supplied in the form of air.

The process is may operated using one or more beds of silicate hydroxide or activated mineral particles. Preferably, each steps (a), (b), and (c) take place in separate beds. Preferably, one or more or steps (a), (b) or (c) are carried out in a fluidised bed, more preferable all steps are performed in fluidised beds.

Fluidised beds provide efficient transfer of heat to the mineral particles and provide an optimal heat distribution throughout the fluidised bed, reducing the creation of hot spots inside the bed. Furthermore, state of the art control of fluidised beds allows for a good temperature control inside the bed.

Preferably, the fluid fuel and molecular oxygen used for generating the energy necessary for activating the preheated silicate hydroxide mineral particles are supplied to the bed of preheated silicate hydroxide mineral particles prior to reaction of the fluid fuel with the molecular oxygen. The combustion of the fuel may take place in the direct vicinity of the bed of preheated silicate hydroxide mineral particles or, preferably, takes place inside the bed of preheated silicate hydroxide mineral particles. Fluidised bed furnaces with internal combustion are generally described in the open literature. An example, where such furnaces are described is: “R. W. Reynoldson, Heat Treatment in Fluidized Bed Furnaces, ASM International, 1993”.

By combusting the fuel inside the bed, the energy necessary to active the silicate hydroxide mineral is produced in-situ. There is no or at least a reduced need to provide additional externally produced energy, for instance by feeding a hot gas, such as syngas, to the bed of preheated silicate hydroxide mineral. Another advantage is that there are less temperature constraints on the design of the reactor. There is no need to use materials capable of withstanding temperatures significantly exceeding 1000° C. or, in case the mineral is serpentine, even 800°. When the fuel is combusted inside the fluidized bed, the off-gas from the fluidised bed is a mixture of flue gas from the combustion and steam generated during the activation.

It will be appreciated that the ratio of silicate hydroxide mineral particles supplied to the fluidised bed and the flow velocity of the fuel and molecular oxygen-comprising gas should be such that sufficient energy can be provided to further heat the silicate hydroxide mineral particles supplied to the fluidised bed to or above the activation temperature and to obtain the desired degree of activation within the residence time of the mineral particle inside the fluidised bed. The suggested control of such a fluidised bed may depend on several conditions including the size of the silicate hydroxide mineral particles supplied to the fluidised bed, flow and choice of fuel and molecular oxygen-comprising gas supplied to the bed of mineral particles, and temperature of the bed. It should be noted that the suggested control of such a fluidised bed falls within the practical knowledge of a person skilled in the art of fluidised beds.

Preferably, in a fluidized bed set to operate step (a), the fluidising agent is the off-gas obtained from the activation step (b), the off-gas is already hot and therefore there is no need to add a separate fluidising agent which needs to be heated. Equally, in a fluidized bed set to operate step (b), the heated molecular oxygen (e.g. air) and/or the fluid fuel are the fluidizing agent. Furthermore, in a fluidized bed set to operate step (c), preferably, molecular oxygen (e.g. air) is used as the fluidizing agent, in this way the energy obtained by cooling the hot activated mineral particles is used for heating the molecular oxygen and not for heating a separate fluidising agent.

If the silicate hydroxide mineral is serpentine, the serpentine particles are preferably preheated in step (a) to a temperature of at least 300° C., more preferably, at least 450° C., even more preferably in the range of from 500 to 600° C.

In the case of serpentine, the activation in step (b) is preferably carried out in a fluidised bed having a temperature in the range of from 500 to 800° C., more preferably of from 600 to 700° C., even more preferably of from 620 to 650° C. At temperatures between 620 to 650° C. a maximum reactivity of the activated mineral toward carbon dioxide was obtained. Below 500° C., there is no significant conversion of serpentine into olivine. Above 800° C., a crystalline form of olivine is formed that is more difficult to convert into magnesium carbonate than the amorphous olivine formed at a temperature below 800° C. It will be appreciated that crystallization of olivine can already occur to some extent at temperatures lower than 800° C., however, it should be realised that this requires prolonged residence times at such temperatures.

If the silicate hydroxide is talc, the fluidised bed preferably has a temperature in the range of from 800 to 1000° C.

As mentioned hereinabove, the residence time of the preheated silicate hydroxide mineral particles under activation conditions is of influence on the activation and resulting composition of the obtained activated mineral. Preferably, the preheated silicate hydroxide particles have a residence time in the fluidised bed in the range of from 1 second to 180 minutes. It will be appreciated that the optimal residence time is dependent on the temperature of the fluidised bed. In case of a fluidised bed temperature of in the range of from 620 to 650° C., the residence time is preferably in the range of from 50 to 70 minutes, more preferably of from 55 to 65 minutes, for example 60 minutes. These residence times provide that a sufficient degree of activation is achieved, while minimising the formation of less desired mineral products.

The silicate hydroxide mineral particles supplied to the fluidised bed preferably have an average diameter in the range of from 10 to 500 w, more preferably of from 150 to 300 v, even more preferably of from 150 to 200 μm. Reference herein to average diameter is to the volume medium diameter D(v,0.5), meaning that 50 volume % of the particles have an equivalent spherical diameter that is smaller than the average diameter and 50 volume % of the particles have an equivalent spherical diameter that is greater than the average diameter. The equivalent spherical diameter is the diameter calculated from volume determinations, e.g. by laser diffraction measurements.

In the process according to the invention, silicate hydroxide mineral particles of the desired size may be supplied to the, fluidised, bed. Alternatively, larger particles, i.e. up to a few mm, may be supplied. As a result of the expansion of the steam formed during the conversion reaction in step (a), the larger particles may fragment into the desired smaller particles.

It will be appreciated that the process conditions such as temperature, residence time and particle size may also be applied when using a fixed bed of silicate hydroxide mineral particles.

Reference herein to magnesium or calcium sheet silicate hydroxide mineral is to silicate hydroxides comprising magnesium, calcium or both. Silicate hydroxides comprising magnesium are preferred due to their abundances in nature. Part of the magnesium or calcium may be replaced by other metals, for example iron, aluminium or manganese. Any magnesium or calcium silicate hydroxide belonging to the group of sheet silicates may be suitably used in the process according to the invention. Examples of suitable silicate hydroxides are serpentine, talc and sepiolite. Serpentine and talc are preferred silicate hydroxides. Serpentine is particularly preferred.

Serpentine is a general name applied to several members of a polymorphic group of minerals having comparable molecular formulae, i.e. (Mg,Fe)₃Si₂O₅(OH)₄ or Mg₃Si₂O₅(OH)₄, but different morphologic structures. In the process according to the invention, serpentine may be converted into olivine or into an amorphous serpentine-derived compound. The olivine may be amorphous or crystalline. Preferably, the olivine is amorphous. The olivine obtained is a magnesium silicate having the molecular formula Mg₂SiO₄ or (Mg,Fe)₂SiO₄, depending on the iron content of the reactant serpentine. Serpentine with a high magnesium content, i.e. serpentine that has no Fe or deviates little from the composition Mg₃Si₂O₅(OH)₄, is preferred since the resulting olivine has the composition Mg₂SiO₄ and can sequester more carbon dioxide than olivine with a substantial amount of magnesium replaced by iron.

Talc is a mineral with chemical formula Mg₃Si₄O₁₀(OH)₂. In process according to the invention, talc may be converted into enstatite, i.e. MgSiO₃, or into amorphous talc.

The fuel used to provide the heat for the activation of the preheated silicate hydroxide mineral may be any fuel that can exothermally react, i.e. be combusted, with oxygen. Such fuels include solid fuels such as coal or biomass. Preferably, the fuel is a fluid fuel, more preferably a gaseous fuel. Suitable fuels include hydrocarbonaceous fuels, hydrogen, carbon monoxide or mixtures comprising of one or more thereof. Examples of suitable fuels include natural gas, associated gas, methane, Heavy Paraffin Synthesis (HPS)-off gas and syngas. These fuels are clean, for instance compared to fuels like coal, and are typically available at carbon dioxide production sites. Syngas generally refers to a gaseous mixture comprising carbon monoxide and hydrogen, optionally also comprising carbon dioxide and steam. Syngas is usually obtained by partial oxidation or gasification of a hydrocarbonaceous feedstock. Examples of processes producing syngas include coal, gas or biomass-to-liquid.

The molecular oxygen-comprising gas may for instance be air, oxygen enriched air or substantially pure oxygen.

When oxygen enriched air or substantially pure oxygen are used the flue gas is less or essentially not diluted with nitrogen. This may be beneficial if the flue gas is to be further treated, for instance by removing carbon dioxide.

If the fuel comprises carbon atoms, fuel and molecular oxygen are supplied such that the oxygen-to-carbon molar ratio is preferably 0.85 or higher, more preferably 0.95 or higher. Even more preferred is that the oxygen-to-carbon molar ratio is in the range of from 0.95 to 1.5. Reference herein to the oxygen-to-carbon molar ratio is to the number of moles of molecular oxygen (O₂) to the number of moles of carbon atoms in the fuel. In such ratios the fuel combusts cleanly and therefore produces a flue gas, which comprises less ashes or other solids. Such ashes and other solids may contaminate the obtained activated mineral.

The fluid fuel and molecular oxygen-comprising gas may be supplied to the bed of silicate hydroxide mineral particles separately or in the form of a mixture comprising the fluid fuel, molecular oxygen and optionally another fluid. If the fluid fuel and molecular oxygen-comprising gas are supplied separately it may be necessary to provide a means for ensuring that both fuel and molecular oxygen are well distributed throughout the bed.

In a further aspect, the invention provides an activated magnesium or calcium sheet silicate hydroxide mineral obtainable by the process according to the invention. This mineral is especially suitable for mineral carbonation of carbon dioxide. Although the exact structural composition of the obtained activated mineral is unknown, it is known that it may contain substantial amounts of amorphous minerals, such as amorphous olivine and/or an amorphous serpentine-derived compound. In contrast, naturally occurring olivine and serpentine are essentially crystalline. It has been found that the reaction rate of carbon dioxide with the activated mineral obtained by the mineral activation process according to the invention is significantly higher than the reaction rate of carbon dioxide with naturally occurring olivine or serpentine.

Another aspect of the invention, provides a process for the sequestration of carbon dioxide by mineral carbonation comprising, besides the mineral activation process according of the invention, contacting the activated magnesium or calcium sheet silicate hydroxide mineral particles with carbon dioxide to convert the activated mineral into magnesium and/or calcium carbonate and silica.

In the mineral carbonation process, the carbon dioxide is typically contacted with an aqueous slurry of the activated mineral particles. In order to achieve a high reaction rate, it is preferred that the carbon dioxide concentration is high, which can be achieved by applying an elevated carbon dioxide pressure. Suitable carbon dioxide pressures are in the range of from 0.05 to 100 bar (absolute), preferably in the range of from 0.1 to 50 bar (absolute). The total process pressure is preferably in the range of from 1 to 150 bar (absolute), more preferably of from 1 to 75 bar (absolute).

A suitable operating temperature for the mineral carbonation process is in the range of from 20 to 250° C., preferably of from 100 to 200° C.

The carbon dioxide may for instance be initially comprised in a flue gas. Reference herein to flue gas is to an off gas of a combustion reaction, typically the combustion of a hydrocarbonaceous feedstock. The combustion of a hydrocarbonaceous feedstock gives a flue gas typically comprising a gaseous mixture comprising carbon dioxide, water and/or optionally nitrogen.

Alternatively, the carbon dioxide may be comprised in the product gas of a water-gas shift reactor, wherein the CO in for instance a syngas is reacted with water to a mixture of hydrogen and carbon dioxide.

A by-product of step (b) is water, which is obtained in the form of steam with the flue gas. The water obtained during the activation may be used for instance to provide an aqueous slurry in the mineral carbonation process according to the invention.

Alternatively, the water obtained during the activation may be recovered from the flue gas and be used for other applications, such as part of the feed to a steam methane reformer, water-gas shift reactor, or be used in the generation of power.

The process according to the invention is particularly suitable to sequester the carbon dioxide in flue gas obtained from boilers, gas turbines, or carbon dioxide in syngas from coal gasification or coal, gas or biomass-to-liquid units. The process according to the invention may advantageously be combined with such processes. Gas turbines are typically fed with natural gas or syngas. Coal gasification and coal, gas or biomass-to-liquid unit comprise producing syngas. Both syngas and natural gas are especially suitable fuels for use in the mineral activation process of the present invention and available at the site of a gas turbine, coal gasification or coal, gas or biomass-to-liquid unit.

In case the flue gas from the mineral activation process comprises carbon dioxide, this carbon dioxide may be sequestrated at least in part by contacting the carbon dioxide with the activated mineral in the mineral carbonation process.

The invention is further illustrated by the following non-limiting examples, wherein the effect of heat integrating the several process steps of the process according to the invention is shown. The calculations were performed using a “PRO-II 7.1” simulation engine.

### EXAMPLE 1 (NOT ACCORDING TO THE INVENTION)

### Activation of Serpentine without Heat Integration

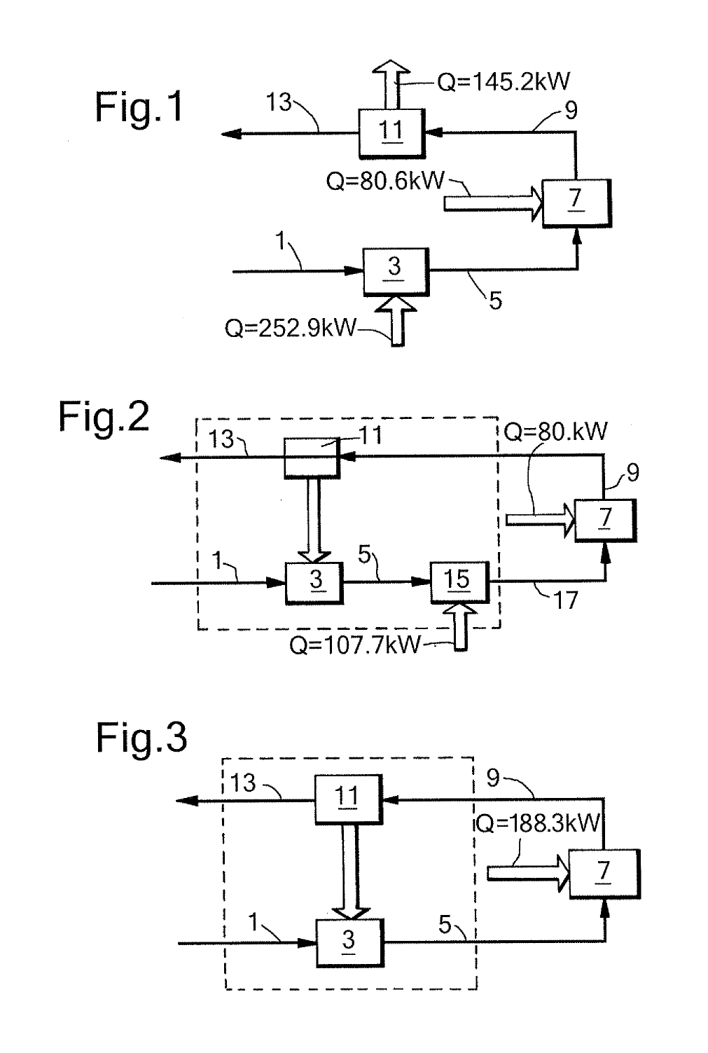

A mineral feedstock comprising serpentine is activated using a process as schematically shown in FIG. 1. Mineral feedstock 1, comprising 75 wt % serpentine and 25 wt % silica, is supplied to preheat unit 3 at a feed rate of 1000 kg/hr, a temperature of 20° C. and a pressure of 1 atm. The mineral feedstock is preheated to 650° C. The energy required for preheating the mineral feedstock is provided externally. Preheated mineral feedstock 5 is supplied to activation unit 7. In activation unit 7, the serpentine in preheated mineral feedstock 5 is activated at a temperature of 650° C. and a pressure of 1 atm. Activation is continued until 99% conversion is achieved. Mineral feedstock comprising activated serpentine 9 (further referred to as activated mineral feedstock) is supplied to cooling unit 11 to obtain cooled activated mineral feedstock 13. Cooled activated mineral feedstock 13 has a temperature of 150° C., which is a suitable temperature for mineral carbonation.

During the above describe activation process 252.9 kW must be supplied to preheat unit 3 and 80.6 kW to activation unit 7. The total energy input in terms of power is therefore 333.5 kW.

### EXAMPLE 2

### Activation of Serpentine Including Mineral Heat Exchange

In a process similar to Example 1, the energy released when cooling activated mineral feedstock 9 is used to preheat mineral feedstock 1 in preheat unit 3 to a temperature of 561° C., i.e. the mineral preheating and cooling steps are heat-integrated. Additional energy required to bring the mineral feedstock 1 to the reaction temperature (650° C.) is supplied by an external source.

In FIG. 2, additional heater unit 15 has been introduced to further heat the preheated mineral feedstock 5 exiting preheat unit 3. However, it will be appreciated that units 3 and 15 may in fact be integrated into one single unit.

Alternatively, as shown in FIG. 3, preheated mineral feedstock 5, having a temperature of 561° C., is supplied directly to activation unit 7 and a higher amount of externally supplied energy may be supplied directly into activation unit 7.

During the above describe activation process 145.2 kW is provided to preheat unit 3 by heat exchange with cooling unit 11. Additionally, 107.7 kW must be supplied to heater unit 15 and 80.6 kW to activation unit 7.

Alternatively, heater unit 15 is omitted and 188.3 kW is directly supplied to activation unit 7. The total energy input is therefore 188.3 kW, a reduction of 43.5%.

### EXAMPLE 3

### Activation of Serpentine Further Including Steam Heat Exchange

In Example 3, a process as described in Example 2, i.e. a process wherein the mineral preheating and cooling steps are heat-integrated, is further improved by utilizing the energy stored in the steam produced during the activation. The steam produced during the activation of serpentine is obtained from activation unit 7 as off-gas having a temperature of 650° C. and is cooled in an off-gas cooler to provide a cooled off-gas having a temperature of 120° C. The energy obtained by cooling the off-gas is additionally used to preheat mineral feedstock 1. By cooling the off-gas to a temperature of at least 120° C., the off-gas is still of a sufficiently high temperature to be conveniently released into the atmosphere.

An additional 29.3 kW can be saved by recovering the energy from the off-gas of activation unit 7.

The total energy input is reduced to 159 kW. The energy savings reach 174.5 kW that cover 52.3% of the total heat required for the activation process.

### EXAMPLE 4

### Activation of Serpentine Including Flue Gas Heat Exchange

In Example 4, a process as described in Example 3, i.e. a process wherein the mineral preheating, mineral cooling and steam cooling steps are heat-integrated, is further improved by combusting, natural gas to give the required energy for the mineral activation process, while heat-integrating the combustion and the mineral activation processes.

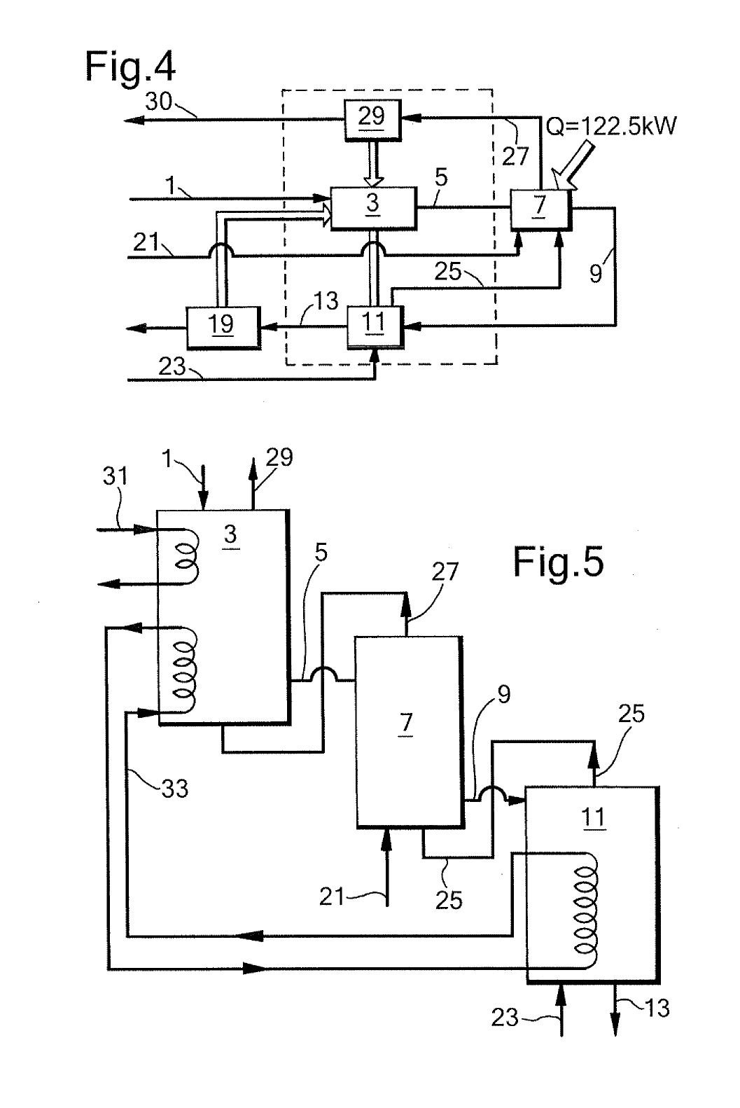

The process is illustrated using the scheme presented in FIG. 4. Mineral feedstock 1 is provided to preheat unit 3. Preheated mineral feedstock 5 having a temperature of 561° C. is supplied to activation unit 7.

Activated mineral feedstock 9 with a temperature of 650° C. is supplied from activation unit 7 to cooling unit 11.

Mineral feedstock 1 is preheated by the energy released when cooling activated mineral feedstock 9. Cooled activated mineral feedstock 13 has a temperature of 150° C. and is subsequently supplied to a mineral carbonation unit 19 together with water and carbon dioxide. During the mineral carbonation process carbon dioxide reacts with the activated serpentine forming magnesium carbonate and silica and steam.

During the process natural gas 21 and air are supplied to activation unit 7 and combusted in the presence of the preheated mineral. The natural gas used for the combustion has a heating value (LHV) of 37861 kJ/m³ and is provided at ambient conditions (temperature 20° C., pressure 1 atm).

Air 23 (79% N₂-21% O₂, under ambient conditions) is preheated by bringing air 23 in heat exchange contacting with activated mineral feedstock 9 in cooling unit 11. Preheated air 25 is supplied to activation unit 7 in an oxygen-to-carbon molar ratio of 1.3. The temperature of preheated air 25 is 600° C.

As a result of the combustion of natural gas 21 inside activation unit 7, off-gas 27 is a mixture of the steam obtained through the mineral activation reaction and the flue-gas produced during the combustion of natural gas 21. As in example 3, the off-gas is cooled in off-gas cooler 29 cooler to provide cooled off-gas 30 having a temperature of 120° C., and the obtained energy is supplied through heat exchange to preheat unit 3.

The steam obtained from the mineral carbonation process is cooled and the heat obtained from this cooling is provided to preheat unit 3.

The total energy input is reduced to 122.5 kW. The energy savings reach 211 kW that cover 63% of the total heat required for the activation process.

In order to facilitate the calculations it was assumed in examples 1 to 4 that a 100% heat recovery was achieved in the heat transfer steps and units. Although it is understood that in reality some loss of heat will occur, it will be clear that the presented efficiency improvement will still be significant if those heat losses are taken into account.

### EXAMPLE 5

### Schematic Representation of a Process Flow Diagram

In FIG. 5 a more elaborate schematically representation is given of an embodiment of the process according to the invention. In FIG. 5 the mineral preheating step is heat-integrated with the mineral cooling process and the mineral activation process. Additionally, the mineral activation process and mineral cooling processes are heat integrated to preheat the air provided to the activation process. As shown in FIG. 5, mineral feedstock 1 enters preheat unit 3. Within preheat unit 3, mineral feedstock 1 is preheated by the use of steam 31, which is recovered from the mineral carbonation section, off-gas 27 and heat transfer medium 33 that recovers the heat from cooling unit 11. Preheated mineral feedstock 5 enters activation unit 7, where the serpentine activation is taking place at 650° C. The energy required for the activation reaction is supplied by internal combustion of natural gas 21 with pre-heated air 25. The activated mineral feedstock 9 is exiting the activation unit 7 and flows to the cooling unit 11, where it is cooled by exchanging heat with air 23 and heat transfer medium 33. Finally, the cooled activated mineral feedstock 13 flows from cooling unit 11 and is ready to enter the mineral carbonation section (not shown).

Pre-heat unit 3 may for instance be a vertical fluidised bed with stages. Mineral feedstock 1 enters at the top of the fluidised bed and is exiting from the bottom. Off-gas 27 that enters at the bottom of the fluidised bed is the fluidisation agent that is cooled at the same time and is exiting from the top fluidised bed. In the upper stages of the staged fluidised bed, where low temperatures exist, the low quality heat from steam 31 obtained from the mineral carbonation is utilized. The low quality heat may be obtained from VLPS (Very Low Pressure—Steam) at a pressure of 2 to 3 bar. As mineral feedstock 1 is flowing from the upper stages to the lower stages at the bottom of the staged fluidised bed a temperature profile develops from low temperature at the upper stages to high temperature at the lower stages. Advantageously, different heat transfer media are utilized at different stages, such as, when going from low temperature to high temperature, Low Pressure Steam (LPS), Medium Pressure steam (MPS) or High Pressure Steam (HPS). Above 300° C., molten salt may preferably be used as heat transfer medium 33. The heat transfer fluids recover the energy from the hot activated mineral at the appropriate temperature levels and are circulated in a closed-loop system. Suitable molten salts include salts comprising 60% NaNO3 and 40% KNO3, which are commercially available under the name HITEC® heat transfer salt (ex Coastal Chemicals).

Cooling unit 11 may be similar to preheat unit 3 pre-heater, however in a reverse mode. In this case, activated mineral feedstock 9 is flowing from the top to the bottom and the temperature profile develops from high temperature at the upper stages of the staged fluidised bed to low temperature at the lower stages. Air 23 that is entering from the bottom is the fluidisation agent that is heated at the same time and exits from the top of the fluidised bed. In cooling unit 11, heat is transferred to heat transfer media 33.

1. A process for the activation of a magnesium or calcium sheet silicate hydroxide mineral comprising:
(a) preheating magnesium or calcium sheet silicate hydroxide mineral particles to obtain preheated silicate hydroxide mineral particles;
(b) activating the preheated silicate hydroxide mineral particles at elevated temperature to obtain at least hot activated mineral particles; and
(c) cooling the hot activated mineral particles,
wherein energy released during cooling in step (c) is used for preheating the magnesium or calcium sheet silicate hydroxide mineral particles in step (a) by heat-integration.

2. A process according to claim 1, wherein in step (b) hot steam is obtained in addition to hot activated mineral particles, and wherein the hot steam is cooled, in which process energy released during cooling of the hot steam is used for preheating the magnesium or calcium sheet silicate hydroxide mineral particles in step (a) by heat-integration.

3. A process according to claim 1, further comprising reacting a fluid fuel with molecular oxygen to provide the heat for activating the preheated silicate hydroxide mineral particles in step (b) while obtaining a hot flue gas and cooling the hot flue gas, in which process energy released during cooling of the hot flue gas is used for preheating the magnesium or calcium sheet silicate hydroxide mineral particles in step (a) by heat-integration.

4. A process according to claim 3, further comprising heating the molecular oxygen prior to reacting the molecular oxygen with the fuel, wherein energy released during cooling in step (c) is used for preheating the molecular oxygen by heat-integration.

5. A process according to claim 1, wherein the energy released during cooling in step (c) is provided to the magnesium or calcium sheet silicate hydroxide mineral particles in step (a) by use of a heat exchanger and/or a fluid heat exchange medium.

6. A process according to claim 1, wherein one or more of steps (a), (b) or (c) are carried out in a fluidised bed.

7. A process according to claim 6, comprising reacting a fluid fuel with molecular oxygen to provide the heat for activating the preheated silicate hydroxide mineral particles in step (b), wherein the fluid fuel and molecular oxygen are supplied to the fluidised bed prior to reaction of the fluid fuel with the molecular oxygen.

8. A process according to claim 1, wherein the magnesium or calcium sheet silicate hydroxide mineral is serpentine.

9. A process according to claim 8, wherein in step (b) the fluidised bed has a temperature in the range of from 500 to 800° C.

10. A process according to claim 3, comprising reacting a fluid fuel with molecular oxygen to provide the heat for activating the preheated silicate hydroxide mineral particles in step (b), wherein the fluid fuel comprises a hydrocarbonaceous fuel, hydrogen or carbon monoxide.

11. A process according to claim 1, comprising reacting a fluid fuel with molecular oxygen to provide the heat for activating the preheated silicate hydroxide mineral particles in step (b), wherein the molecular oxygen is comprised in a molecular oxygen-comprising gas.

12. A process according to claim 1, wherein the magnesium or calcium sheet silicate hydroxide mineral particles have an average diameter in the range of from 10 to 500 μm.

13. Activated magnesium or calcium sheet silicate hydroxide mineral obtainable by the process according to claim 1.

14. Process for sequestration of carbon dioxide by mineral carbonation comprising contacting activated magnesium or calcium sheet silicate hydroxide particles obtained by a process according to claim 1 with carbon dioxide to convert the silicate into magnesium or calcium carbonate and silica.

15. A process according to claim 1, wherein in step (b) hot steam is obtained in addition to hot activated mineral particles, and wherein the hot steam is cooled, in which process energy released during cooling of the hot steam is used for preheating the magnesium or calcium sheet silicate hydroxide mineral particles in step (a) by heat-integration by directly contacting the hot steam with the magnesium or calcium sheet silicate hydroxide mineral particles.

16. A process according to claim 2, further comprising reacting a fluid fuel with molecular oxygen to provide the heat for activating the preheated silicate hydroxide mineral particles in step (b) while obtaining a hot flue gas and cooling the hot flue gas, in which process energy released during cooling of the hot flue gas is used for preheating the magnesium or calcium sheet silicate hydroxide mineral particles in step (a) by heat-integration.

17. A process according to claim 1, further comprising reacting a fluid fuel with molecular oxygen to provide the heat for activating the preheated silicate hydroxide mineral particles in step (b) while obtaining a hot flue gas and cooling the hot flue gas, in which process energy released during cooling of the hot flue gas is used for preheating the magnesium or calcium sheet silicate hydroxide mineral particles in step (a) by heat-integration by directly contacting the hot flue gas with the magnesium or calcium sheet silicate hydroxide mineral particles.

18. A process according to claim 2, further comprising reacting a fluid fuel with molecular oxygen to provide the heat for activating the preheated silicate hydroxide mineral particles in step (b) while obtaining a hot flue gas and cooling the hot flue gas, in which process energy released during cooling of the hot flue gas is used for preheating the magnesium or calcium sheet silicate hydroxide mineral particles in step (a) by heat-integration by directly contacting the hot flue gas with the magnesium or calcium sheet silicate hydroxide mineral particles.

19. A process according to claim 15, further comprising reacting a fluid fuel with molecular oxygen to provide the heat for activating the preheated silicate hydroxide mineral particles in step (b) while obtaining a hot flue gas and cooling the hot flue gas, in which process energy released during cooling of the hot flue gas is used for preheating the magnesium or calcium sheet silicate hydroxide mineral particles in step (a) by heat-integration.

20. A process according to claim 15, further comprising reacting a fluid fuel with molecular oxygen to provide the heat for activating the preheated silicate hydroxide mineral particles in step (b) while obtaining a hot flue gas and cooling the hot flue gas, in which process energy released during cooling of the hot flue gas is used for preheating the magnesium or calcium sheet silicate hydroxide mineral particles in step (a) by heat-integration by directly contacting the hot flue gas with the magnesium or calcium sheet silicate hydroxide mineral particles.
